(19) United States
(12) Patent Application Publication
(10) Pub. No.: US 2011/0139075 A1
(43) Pub. Date: Jun. 16, 2011

(54) System and Method for Production of Predatory Mites

(76) Inventors: David I. Shapiro Ilan, Macon, GA (US); W. Louis Tedders, Perry, GA (US); Juan A. Morales Ramos, Greenville, MS (US); Maria G. Rojas, Greenville, MS (US)

(21) Appl. No.: 12/636,245

(22) Filed: Dec. 11, 2009

(51) Int. Cl. A01K 29/00

(52) U.S. Cl. 119/6.5; 119/6.7; 119/651; 119/300

(57) ABSTRACT

The insect inoculation system and method optimizes the conditions wherein host insect cadavers are infected by a selected parasite. Host insect cadavers are exposed to the selected parasite within the inoculation chamber. The inoculation chamber is configured to optimize the parasite infection and reproduction process. The insect parasites produce multiple offspring which remain in the infected insect cadavers. At the end of the inoculation process, the infected cadavers are removed from the chamber and the insect parasites are harvested and used in bio-pest control processes.

### FIELD OF THE INVENTION

The present invention relates to a system and method for inoculating insect cadavers. Specifically, the invention relates to a system and method of inoculating insect cadavers with nematodes so that the nematodes reproduce in large numbers within the cadavers and are available for subsequent harvesting for use in biologically-based pest control processes.

### BACKGROUND OF THE INVENTION

For multiple reasons, farmers are seeking biologically-based pest control alternatives to commercial synthetic chemical pesticides. One “biocontrol” strategy is to increase the presence of the insects' natural enemies. These natural enemies may include beneficial entomopathogenic nematodes such as Steinernema spp or Heterorhabditis spp. These beneficial nematodes are parasites that prey on a variety of damaging insects but pose no danger to plants or humans.

Commercial production of beneficial nematodes can be in vitro (e.g., in fermentation tanks), or in vivo using susceptible insect hosts. Although both production systems have advantages, in vivo systems generally result in the production of better quality and more virulent nematodes. Further, more nematode species can be produced in vivo, and in vivo production methods do not require the use of expensive and complex equipment.

In vivo production of nematodes requires the relatively large scale inoculation of host insects so that the nematodes can reproduce and subsequently be harvested for commercial pest control application. In the past, nematodes were simply applied to a designated area and the insect cadavers were deposited in the area so that the nematodes migrated into the cadavers. The container was then covered and stored for a variable amount of time. Nematodes were then harvested from the infected insect cadavers.

However, the prior art process resulted in the production of an inconsistent number of nematodes that varied in vitality, virulence, and overall quality. The need exists for a systematic method and apparatus that optimizes the nematode production process so that a consistent number of healthy nematodes are reliably produced. The chamber of the current invention provides a convenient and efficient modular system that creates an optimal environment for the infection of insect cadavers and the reproduction of nematodes. The process of the current invention ensures that the maximum numbers of nematodes are produced per each insect host, and that the nematodes are healthy and capable of performing their pest control function.

### SUMMARY OF THE INVENTION

The current invention is directed to an inoculation system. The inoculation system includes a host organism (mealworm larva) and selected parasites (nematodes) that are compatible with the host organism. The organism and the parasites are deposited on one of a plurality of trays within an enclosed inoculation chamber. The host organism and the parasites are left in the inoculation chamber until the parasites infect the host organism.

The current invention is also directed to a method of inoculating host insects with parasites. Host insects and compatible parasites are selected and deposited on a slidable tray within an enclosable inoculation chamber. Each of the trays in the inoculation chamber is capable of accommodating at least one host insect. At least one host insect and the parasites are enclosed within the chamber until the parasites infect the host insect.

### BRIEF DESCRIPTION OF THE DRAWINGS

FIG. 1 is a perspective view of an inoculation enclosure.

FIG. 2 is a perspective view of an alternative embodiment of the enclosure.

### DETAILED DESCRIPTION OF PREFERRED EMBODIMENTS

The present invention is directed to an inoculation chamber that optimizes the conditions wherein host insect cadavers are infected by a selected parasite. In accordance with the current invention, host insect cadavers are exposed to the parasite within a chamber configured to optimize the parasite infection and reproduction process. Each insect parasite produces multiple offspring which remain in the infected insect cadavers. At the end of the inoculation process, the infected cadavers are removed from the chamber and the insect parasites are harvested and used in bio-pest control processes.

In the preferred embodiment, the host insects are mealworm larvae (Tenebrio molitor) and the insect parasites are nematodes (Steinernema spp or Heterorhabditis spp). These beneficial nematodes prey on a variety of damaging insects but pose no danger to plants or humans. Mealworm larvae are selected as a host insect because the larvae are relatively easy to mass produce, readily susceptible to infection by many nematode species, and the infected mealworm larvae cadavers are resilient enough to be manipulated without breakage or disintegration.

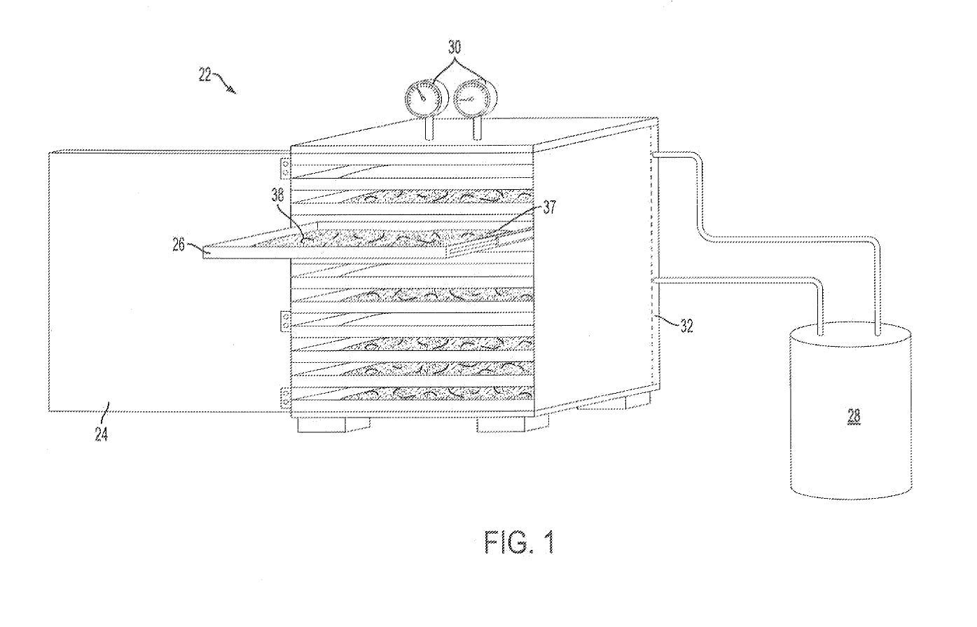

As generally shown in FIG. 1, in the preferred embodiment, the inoculation chamber 22 is generally comprised of a cabinet having an outer door 24 and a plurality of sliding tray-type drawers 26. In the preferred embodiment, closing the outer door 24 seals the interior of the chamber 22.

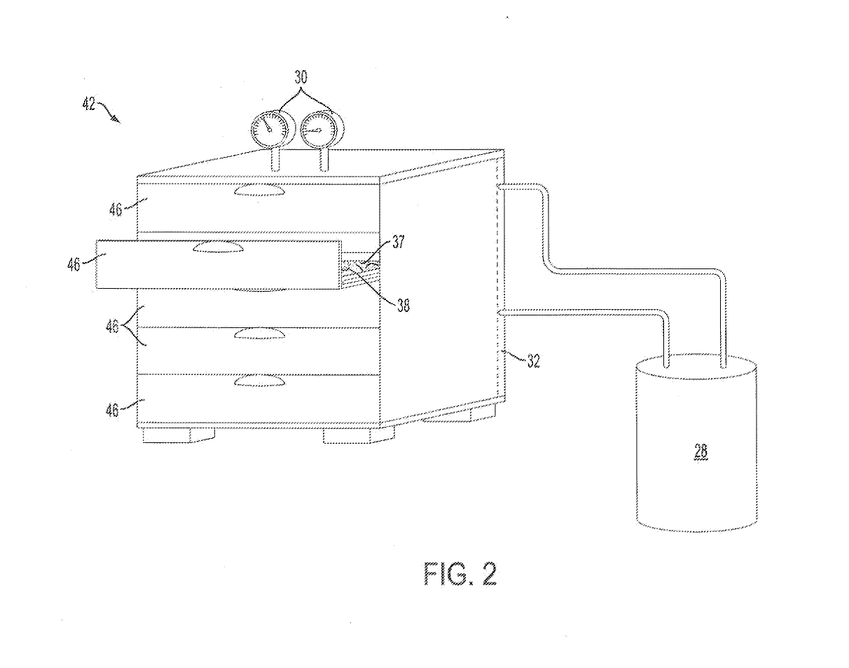

FIG. 2 generally shows an alternative chamber embodiment 42. In the alternative embodiment, a front portion of the sliding tray-type drawers 46 is enlarged so that a front portion of the drawers 46 creates a seal with a front portion of the chamber 42. Consequently, no outer door 24 is required to effectively seal the chamber 42 interior and thereby maintain selected environmental conditions within the chamber 42.

As shown in FIGS. 1 and 2, the interior of the drawers 26, 46, comprises a relatively flat base. Although the interior of all of the drawers 26, 46 is configured essentially the same, only one exemplary drawer 26, 46 is shown as extended in each of FIGS. 1 and 2.

As generally shown in FIGS. 1 and 2, the chamber 22, 42 is connected to an environmental control module 28. The environmental control module 28 is a means of controlling the environment within the chamber and is described in detail infra. The inventors have found that the nematode reproduction process is optimized by maintaining a high humidity environment and a moderate temperature within the chamber 22, 42. Specifically, in the preferred embodiment, Steinernema and Heterorhabditis nematode production (and reproduction) is optimized when relative humidity is maintained between 95% and 99%, and temperature is maintained between 23° and 28° C., with the optimal temperature being 25° C. (77° F.). Monitoring gauges 30 displaying temperature and relative humidity respectively are disposed on the outer portion of the chamber 22, 42.

In the preferred embodiment, the environmental control module 28 is connected to a duct space 32 in the rear of the chamber 22, 42. The duct space 32 is in communication with an area above the respective drawers 26, 46 so that air flowing from the environmental control module 28 is circulated throughout the interior of the chamber 22, 42, thereby maintaining at least a pre-selected temperature and relative humidity within the chamber 22, 42. In alternative configurations, the duct space 32 may extend vertically on either side of the drawers 26, 46, or the duct space 32 may be located at the top or bottom of the chamber 22, 42 and the drawers 26, 46 may be narrowed or ventilated to allow air to circulate above the interior of each of the drawers 26, 46 as described supra. A condensation collection pan or other condensation gathering means (not shown) may be disposed in the bottom of the camber 22, 42 to collect any condensation accumulated during the inoculation and incubation process.

Multiple acceptable types of environmental control modules 28 are well known in the art. The environmental control module 28 may be operated manually or automatically via a programmable computer-controlled link. The status of the environmental control module 28 may be monitored and/or controlled directly or wirelessly to ensure the integrity of the system.

The environmental control module 28 may be as simple as a spray or bubble-inducing device that is in communication with the chamber 22, 42, or the control module 28 may be a precision computer-controlled instrument capable of precisely maintaining environmental conditions within the chamber 22, 42. The environmental control module 28 may also control heating and/or cooling elements (such as fluid pipes or electrical elements) that are embedded in the inner surfaces of the chamber 22, 42. The module 28 may be remote from the chamber 22, 42, or the module 28 may be rigidly attached or “built in” to the chamber 22, 42.

In additional alternative embodiments, the environmental control module 28 may also control and monitor an expanded scope of the environmental conditions within the chamber 22, 42 such as pressure, dew point, density altitude, various physical or chemical ratios, or any other aspects of the chamber 22, 42 environment that may affect the infection of the host insects or the production of nematodes. The environmental control module 28 may be capable of controlling the chemical environment within the chamber 22, 42 by (for example) enriching the oxygen content of the chamber atmosphere or otherwise varying the content of the chamber “air”. The environmental control module 28 may also filter the chamber air or restrict the environmental conditions within the chamber 22, 42 to a wider or a more narrow temperature and relative humidity range than the range described supra.

In further alternative embodiments, the environmental control module 28 may be omitted completely. In one embodiment the aqueous inoculation solution alone (described infra) elevates the humidity within the sealed cabinet. In an additional embodiment, the cabinet enclosure is not sealed. A plastic bag (or other impermeable ventilation restricting means) is placed over the chamber so that the humidity from the inoculation process is at least partially retained within the chamber.

The process of inoculating the host insects will now be described in greater detail.

In operation, a technician places an absorbent substrate 37 at the bottom of each of the chamber drawers 26, 46. In the preferred embodiment, the substrate 37 is comprised of at least one Scott*R paper towel manufactured by Kimberly-Clark Professional and distributed by Kimberly-Clark Global Sales, Inc., Roswell, Ga. 3006-2199. In alternative embodiments, the substrate may be comprised of other absorbent or semi absorbent substrates including plaster of Paris or the like.

In preparation for deposition in the chamber 22, 42, the insect parasites (i.e. the nematodes) are suspended in an aqueous solution. The nematode-bearing solution is then deposited on the substrate 37 so that the substrate 37 generally absorbs most of the solution and the solution dampens the substrate 37. The solution may be transferred to the substrate 37 via a pipette or a specially adapted spray device, or by any means known in the art. As shown in FIGS. 1 and 2, once the nematodes are in place on the dampened substrate 37, the host insects (i.e. the mealworm larvae) 38 will also be deposited on the substrate 27, 47.

The number of nematodes applied to the substrate 37 is based on the genera of the nematode used in the inoculation process. For example, approximately 150-250 Steinernema nematodes are deposited on the substrate 37 per each mealworm larva 38 designated for infection. However, approximately 1800-2400 Heterorhabditis nematodes may be deposited per each mealworm larva 38. In general, the Steinernema nematodes are more virulent to the mealworm larva than the Heterorhabditis.

Similarly, the number of mealworm larvae 38 deposited on the substrate 37 per drawer 26, 46 is based on the size of the drawer 26, 46, and is also a function of the genera of the inoculation nematode. Steinernema nematodes optimally prefer more separation between host cadavers than do the Heterorhabditis.

After the nematodes and mealworm larvae 38 have been deposited in the inoculation chamber 22, 42, the chamber 22, 42 is closed and the nematodes are allowed to incubate. During the incubation period, the nematodes migrate from the dampened substrate 37 into the mealworm larvae 38. Bacteria (Xenorhabdus for steinernematids, Photorhabdus for heterorhabditids) carried by the nematodes kill the larvae 38 and the nematodes reproduce and feed on the bacteria and the larvae cadavers 38. Cadavers 38 that have been successfully infected turn a yellow-brown (steinernematids) or red (heterorhabditids) color. In the preferred embodiment, the nematodes incubate within the chamber 22, 42 for approximately 96 hours (4 days). At the end of the incubation period, the infected mealworm cadavers 38 are removed and the nematodes are extracted from the cadavers 38.

For the foregoing reasons, it is clear that the invention provides an innovative system and method for inoculation of host insects (mealworm larvae) with a parasite (nematodes). The invention may be modified in multiple ways and applied in various technological applications. For example, other types of host organisms may be infected in the chamber 22, 42, and other parasites (or other genera of nematodes) may also be used to infect a host. These applications should be considered within the scope of the current invention.

Additionally, the current invention may be further customized as required by a specific operation or application, and the individual components may be modified and defined, as required, to achieve a desired result. Although the materials of construction are not described, they may include a variety of compositions consistent with the function of the invention. Such variations are not to be regarded as a departure from the spirit and scope of the invention, and all such modifications as would be obvious to one skilled in the art are intended to be included within the scope of the following claims.

What is claimed is:

1. An inoculation system comprising:
a host organism,
a parasite compatible with the host organism,
an enclosable inoculation chamber, and
a plurality of slidable trays disposed within the inoculation chamber,
wherein the parasite and the host organism are deposited on at least one of the slidable trays and the chamber is closed until the parasite infects the host organism.

2. The inoculation system of claim 1 wherein the host organism is an insect.

3. The inoculation system of claim 2 wherein the parasite is a nematode.

4. The inoculation system of claim 3 wherein the host organism is a mealworm larva.

5. The inoculation system of claim 1 wherein the parasite is a nematode of the genera Steinernema or Heterorhabditis.

6. The inoculation system of claim 1 wherein the chamber is sealed and further comprises an environmental control means which elevates humidity within the chamber above a level of humidity of air outside the chamber.

7. The inoculation system of claim 6 wherein the environmental control means elevates humidity within the chamber to between 95% and 99%.

8. The inoculation system of claim 6 wherein the environmental control means maintains a temperature between 20° C. and 30° C.

9. The inoculation system of claim 6 wherein the environmental control means is connected to the chamber so that the environmental control means is in fluid communication with a duct space in the chamber.

10. The inoculation system of claim 1 further comprising a substrate disposed within at least one of the plurality of slidable trays, the parasite being placed in an aqueous solution, the solution and associated parasite being selectively applied to the substrate.

11. The inoculation system of claim 10 wherein the substrate is comprised of an absorbent material so that the substrate absorbs the solution.

12. The inoculation system of claim 1 further comprising at least one gauge operatively associated with the chamber so that an operator can read the at least one gauge from outside the chamber.

13. The inoculation system of claim 1 further comprising a temperature gauge and a relative humidity gauge connected to the chamber so that the gauges are visible from outside the chamber.

14. The inoculation system of claim 1 further comprising an outer door so that closing the outer door seals the chamber.

15. The inoculation system of claim 1 configured so that each of the slidable trays comprises a drawer.

16. The inoculation system of claim 15 wherein a front portion of each drawer creates a seal with a front portion of the chamber, a rear portion of each drawer abuting a duct space, the rear portion being configured so that an area above the drawer is in fluid communication with the duct space.

17. The inoculation system of claim 1 wherein the chamber is not sealed, an outer portion of the chamber being at least partially enclosed by a ventilation restricting means.

18. A method of inoculating a host insect with a parasite, the method comprising:
providing a host insect,
selecting a parasite compatible with the host insect,
obtaining an enclosable inoculation chamber having a plurality of slidabe trays, each of the trays being capable of accommodating at least one host insect,
depositing the host insect and the parasite on at least one of the slidable trays, and
closing the chamber until the parasite infects the host insect.

19. The method of claim 18 wherein the host insect is a mealworm larva and the parasite is nematode.

20. The method of claim 18 wherein, in the obtaining step, the inoculation chamber includes an environmental control means that controls humidity within the chamber.
